(19) United States
(12) Patent Application Publication
(10) Pub. No.: US 2021/0056618 A1
(43) Pub. Date: Feb. 25, 2021

(54) TRANSFERRING TRANSACTIONS BETWEEN FINANCIAL INSTITUTIONS

(71) Applicant: MJB HoldCo, LLC, West Des Moines, IA (US)

(72) Inventors: Mark Brown, Waukee, IA (US); Jeff Ackley, West Des Moines, IA (US)

(21) Appl. No.: 16/998,069

(22) Filed: Aug. 20, 2020

Related U.S. Application Data
(60) Provisional application No. 62/889,466, filed on Aug. 20, 2019.
(60) Provisional application No. 62/907,874, filed on Sep. 30, 2019.

(51) Int. Cl. G06Q 40/02; G06Q 50/26; G06Q 30/02; G06Q 40/00; G06N 5/04

(52) U.S. Cl. CPC G06Q 40/02; G06Q 50/265; H04L 67/12; G06Q 40/12; G06N 5/04; G06Q 30/0201

(57) ABSTRACT

The present disclosure provides for identification of recurring transactions to transfer to a financial institution. Potential service providers that may provide services to a user are identified based on received user information. A selection of service providers from a list of the identified potential service providers is received and recurring transactions are identified between the user and the selected service providers. The identified recurring transactions are exported to the financial institution.

### CROSS-REFERENCE TO RELATED APPLICATIONS

This application claims priority to U.S. Provisional Application No. 62/889,466, entitled “Transferring Transactions Between Financial Institutions,” filed on Aug. 20, 2019, and U.S. Provisional Application No. 62/907,874 entitled “Transferring Transactions Between Financial Institutions,” filed on Sep. 30, 2019, both of which are hereby incorporated by reference in their entireties.

### BACKGROUND

Automatic recurring transactions are a prevalent method of, for example, paying recurring bills or receiving a recurring pay check as a deposit. Often, automatic recurring transactions act as a barrier to switching banks, financial institutions, or credit cards because of the difficulty of transferring automatic recurring transactions from one account to another. For example, a user switching banks may need to log into several different vendor, employer, or banking systems to effect transfers of recurring transactions from an account at an established bank to an account at a destination bank. In the process of manually transferring automatic recurring transactions, a user may overlook transactions that do not occur as frequently, such as quarterly or yearly transactions. Further, because the process of manually transferring automatic recurring transactions is tedious, users may miss financial incentives to switch banks.

It is therefore desirable to provide a bank transfer system that identifies and transfers recurring transactions from an established bank to a destination bank.

### SUMMARY

The present disclosure provides for identification of recurring transactions to transfer to a financial institution. Potential service providers that may provide services to a user are identified based on received user information. A selection of service providers from a list of the identified potential service providers is received and recurring transactions are identified between the user and the selected service providers. The identified recurring transactions are exported to the financial institution.

Additional embodiments and features are set forth in part in the description that follows, and will become apparent to those skilled in the art upon examination of the specification or may be learned by the practice of the disclosed subject matter. A further understanding of the nature and advantages of the present disclosure may be realized by reference to the remaining portions of the specification and the drawings, which forms a part of this disclosure. One of skill in the art will understand that each of the various aspects and features of the disclosure may advantageously be used separately in some instances, or in combination with other aspects and features of the disclosure in other instances.

### BRIEF DESCRIPTION OF THE DRAWINGS

The description will be more fully understood with reference to the following figures in which components are not drawn to scale, which are presented as various examples of the present disclosure and should not be construed as a complete recitation of the scope of the disclosure, characterized in that:

FIG. 1 is a schematic diagram of an example bank transfer system according to some embodiments described in the present disclosure;

FIG. 2 is an example user interface of a bank transfer system;

FIG. 3 is a flow diagram of steps to transfer recurring transactions from an established bank to a destination bank using a bank transfer system;

FIG. 4 is a flow diagram of identifying and transferring recurring transactions using a bank transfer system;

FIG. 5 is an example user interface of a bank transfer system;

FIG. 6 is a flow diagram of transferring recurring transactions using a bank transfer system;

FIG. 7 is a schematic diagram of an example computer system for implementing various embodiments in the examples described herein.

### DETAILED DESCRIPTION

According to the present disclosure, a bank transfer system is provided. The bank transfer system identifies and transfers recurring transactions from an account at a first financial institution, such as an established bank, to an account at a secondary financial institution, such as a destination bank. The bank transfer system may connect directly to vendor, banking, and other systems to identify and transferring recurring transactions between financial institutions. In one example, the system accesses a user's transaction history as a first institution that extends over a predetermined time period, e.g., 6 months to a year. The transaction history, including payment information, amounts, dates, type of transaction, party (e.g., payee or payer) information, is then analyzed to determine transactions that are likely recurring transactions or otherwise include repeating trend information. Identified transactions may then be presented to the user to allow selection of transactions to be transferred to the new financial institution or bank. As transactions are identified as to be transferred, the system then automatically captures or generates transaction transfer information (e.g., payment amounts, payee/payer, transfer date, account information, frequency, etc.), and provides the transfer transaction data to the new financial institution.

As the system is able to automatically identify recurring transactions, transfer the transactions, and translate the data into the format for the new institution, users can more freely change between financial institutions, without worrying that “auto pay” accounts and other repeated or scheduled transfers may be forgotten. Additionally, the conversion of accounts between institutions and vendors allows translation of payments or debits not previously possible. For example, for recurring transactions that are push transactions, the bank transfer system may transfer vendor information from the established bank to the destination bank so that the push transactions may be initiated from the destination bank in the next payment cycle. In contrast, to manually transfer push transactions, a user may log in to vendor accounts separately and update account information from the established bank to the destination bank. The vendors and the established bank may then communicate to establish the push transactions from the established bank to the vendors. The bank transfer system may also save computing resources in transferring recurring pull transactions by directly updating vendor systems with account information from the destination bank.

In one implementation, the bank transfer system is used to identify and transfer recurring transactions from a first credit card to a second credit card. Instead of updating account information in vendor systems for recurring pull transactions, the bank transfer system updates credit card information in vendor systems. The bank transfer system may transfer recurring push charges directly to the credit card account. Further, in this implementation, the bank transfer system may populate the user's bank account information for automatic payments on a new credit card when the user had automatic payments from the bank account set up on the established credit card.

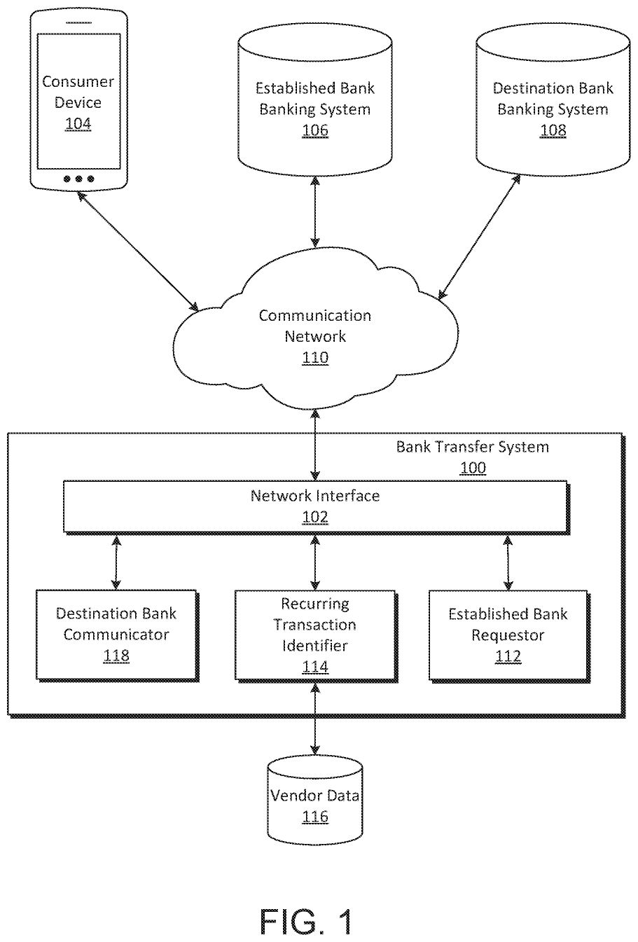

FIG. 1 is a schematic diagram of an example bank transfer system 100 according to some embodiments described in the present disclosure. The bank transfer system 100 includes a network interface 102 that can communicate with a consumer device 104, an established bank banking system 106, and a destination bank banking system 108 through a wireless network 110. A user may log into bank accounts in the established banking system 106 and the destination banking system 108 using an application programming interface (API) that allows the bank transfer system 100 to communicate with the established banking system 106 and the destination banking system 108. The user communicates with the bank transfer system 100 via the consumer device 104. For example, the bank transfer system 100 may present a user interface on the consumer device 104 to collect the user's log in information for the API.

In other implementations, the bank transfer system 100 may include a data structure including user e-mails. Accordingly, the bank transfer system 100 may present a user interface to the user on the consumer device 104 to collect the user's password for the established bank banking system 106 and the user's social security number. The bank transfer system 100 then identifies the proper APIs to allow interaction with the established bank banking system 106 and accessing the established bank banking system 106 using the user's e-mail and password. The bank transfer system 100 may also send a verification message to the user's e-mail or through SMS message to the consumer device 104.

In some implementations, the bank transfer system 100 may also verify the user's identity and collect additional information through identification verification. For example, the bank transfer system 100 may prompt the user to upload an image of the user's government identification (e.g., the user's driver's license or passport). The bank transfer system 100 may also prompt the user to use a camera location on the consumer device 104 to submit a current image of the user. In some implementations, a third-party system may be used to match the current image of the user with a photo on the government identification. The third-party system may also verify that the government identification is valid. The bank transfer system 100 may collect additional information from the user's uploaded government identification using, for example, optical character recognition.

In another implementation, the bank transfer system 100 presents an interface on the consumer device 104 for the user to enter a username for the established bank banking system 106 and the corresponding password along with the user's social security number. The bank transfer system 100 then identifies the proper APIs to allow interaction with the established bank banking system 106.

Once the bank transfer system 100 has established a connection to the established bank banking system 106, an established bank requestor 112 of the bank transfer system 100 requests transaction information from the established bank banking system 106. Transaction information may include information about the user's accounts at the established bank including, for example and without limitation, transaction dates, transaction amounts, vendors, and/or other metadata such as a transaction description or the like. In some implementations, the user may select a subset of accounts at the established request for the established bank requestor 112 to request from the established bank banking system 106. The established bank requestor 112 may request transaction information for a specified time period, such as the previous year. Alternatively, the established bank requestor 112 may request as much transaction information as is available for the accounts in the established bank banking system, up to two years. In one implementation, if the established bank requestor 112 does not receive at least three months of transaction data, an error is presented to the user.

The transaction information received from the established banking system 106 sends the requested transaction information to the bank transfer system 100 through the communication network 110. The transaction information is then passed to a recurring transaction identifier 114. The recurring transaction identifier 114 uses an algorithm to identify transactions in the received transaction information that may be recurring transactions.

The algorithm analyzes transactions in the transaction data to determine whether a particular transaction is a recurring transaction. For example, the algorithm looks for automatic clearing house (ACH) transactions that occur around a similar date each month, e.g., occur on the first of every month over two or more months. Transactions with the same vendor in similar amounts a determined period (e.g. over two or more months) may also be identified as recurring. The algorithm may identify both recurring payments (such as automatic and manual bill payments occurring at a similar time each month) and recurring deposits (such as paychecks). The algorithm may look at all of the transaction history for an account as a whole to identify recurring transactions that occur, for example, quarterly, yearly, monthly, or biweekly.

In one implementation, the algorithm assigns each transaction with a certainty score, indicating the certainty that the transaction is a recurring transaction. Transactions that receive a certainty score above a threshold certainty score may then be identified as recurring transactions. The certainty score may be influenced by a number of factors including, for example and without limitation, frequency of occurrence of the transaction, consistency of frequency of occurrence of the transaction, whether the transaction is an ACH transaction, and variation between amounts of the transaction.

In the implementation shown in FIG. 1, the recurring transaction identifier 114 may access vendor data 116. The vendor data 116 may be used to format vendor information from the transactions identified as recurring transactions by the recurring transaction identifier 114. For example, vendor names listed on bank statements are frequently different from a common name or business name of the vendor. The vendor data 116 may include a database of vendor names as listed on bank statements with the corresponding common vendor or consumer-facing names, which may then be used as a look up table or other translation mechanism. Using this information, the identified recurring transactions may be formatted for readability and be more readily identifiable by a user before it is presented.

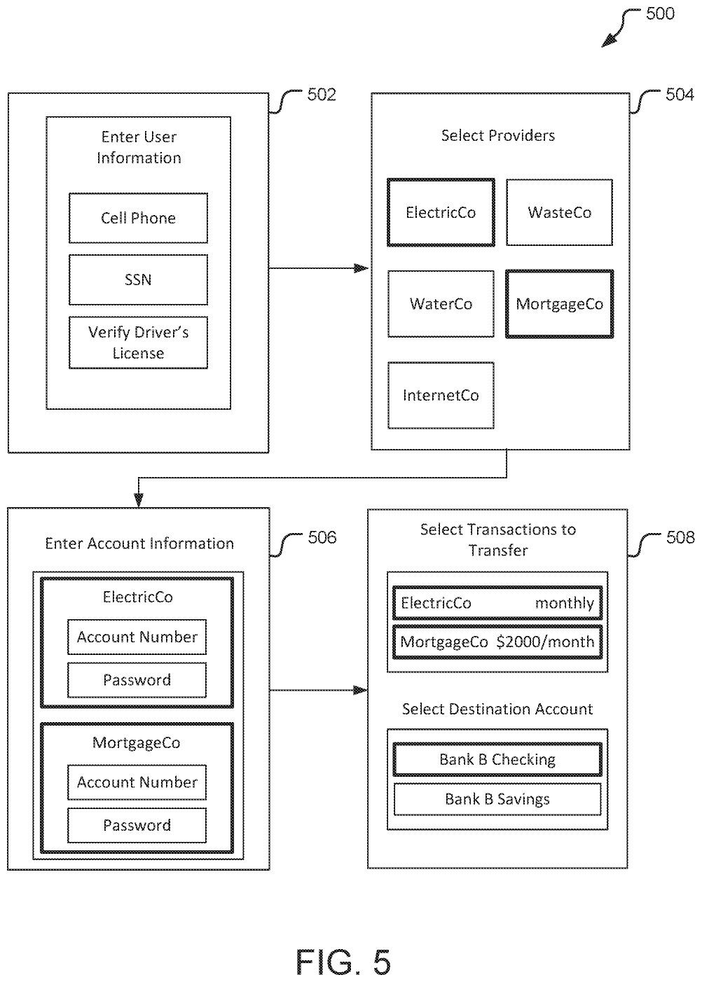

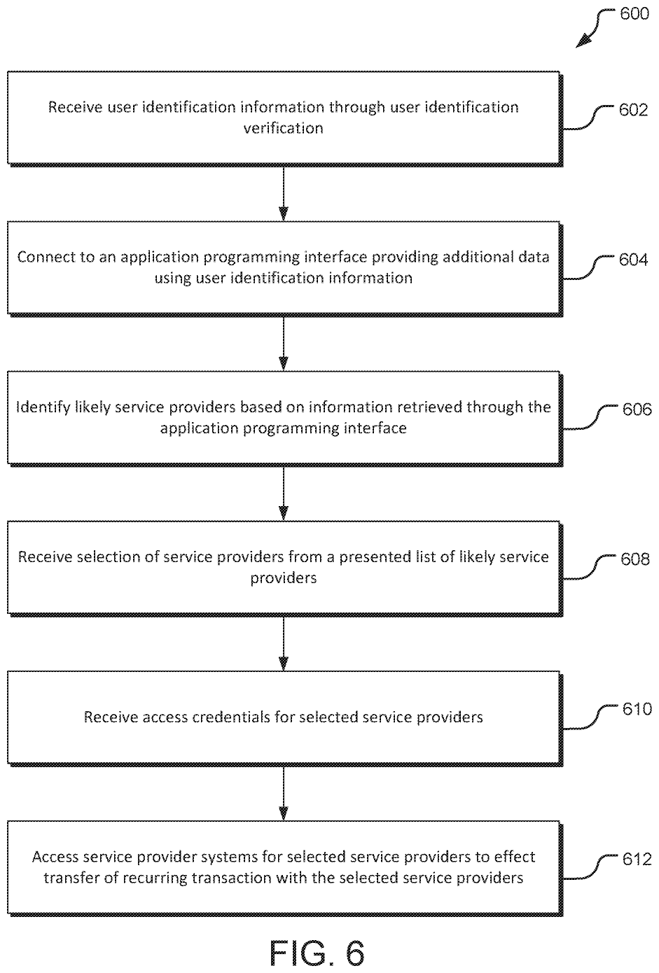

In some implementations, the recurring transaction identifier 114 may identify recurring transactions occurring outside of the established bank. For example, the user may have recurring transactions that occur on a credit card. Using identification verification and additional user information, the recurring transaction identifier may connect to a real estate API to identify real estate owned by the user and service providers (such as utility providers) that service the address of the real estate. This identification may occur in place of identification through the established bank or may supplement identification through the established bank. Additional recurring transactions may occur between the user and the identified service providers. This implementation is discussed in more detail with respect to FIGS. 5 and 6.

In some implementations, the recurring transaction identifier 114 presents the identified recurring transactions to the user on the consumer device 104 before transferring the identified recurring transactions to the destination bank banking system 108. The identified recurring transactions may be presented as a list on the consumer device 104, with the user having the option to select which of the identified recurring transactions to transfer to the destination bank banking system 106. In some implementations, the user may also have the option to manually enter information about recurring transactions that the recurring transaction identifier 114 did not identify.

The identified recurring transactions to transfer to the destination bank banking system 108 are passed to a destination bank communicator 118. The destination bank communicator 118 formats the identified recurring transactions for transfer to the destination banking system 108. For example, the destination bank communicator translates the format of the identified transactions to match the destination bank system.

In some implementations, the destination bank communicator 118 also assists the user with identifying a destination bank and opening an account at the desired destination bank. The destination bank communicator 118 may present different account types, interest rates, fees, and the like, available at various destination banks, where the selection of particular account options is based on information received from the user and the established bank banking system 106. When the user has selected a destination bank, the destination bank communicator 118 uses an API to connect the user to the destination bank banking system 108.

To complete the transfer of recurring transactions to the destination bank banking system 108, the destination bank communicator 118 provides information about the recurring transactions to the destination bank banking system 108. For example, the destination bank communicator 118 provides information about the vendor, transaction frequency, transaction timing, transaction amount, and type of transaction to the destination bank banking system 108. For push transactions, where the bank “pushes” out payment to the vendor, the destination bank banking system 108 is configured to push out payment to the vendor in the correct amount at the correct time from the user's account. For pull transactions, where the vendor “pulls” payment from the user's account, the destination bank banking system 108 updates the account information on file with the vendor from the established bank to the destination bank. In some implementations, the bank transfer system 100 will prompt the user, through the consumer device 104, to log into any accounts through vendors who use pull transactions to facilitate the updating of account information by the destination bank banking system 108.

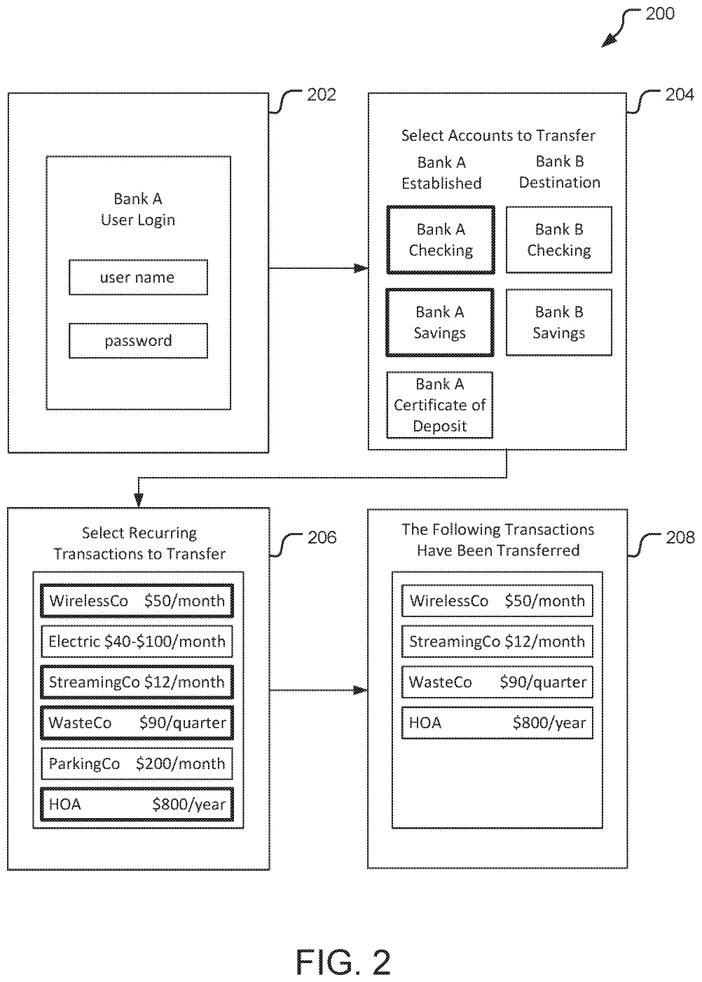

FIG. 2 is an example of the progression of a user interface 200 of a bank transfer system. The progression of the user interface 200 may be presented to the user in response to selection by the user of an option to use the bank transfer system to identify recurring payments in the user's current accounts at an established bank. A first user interface 202 displays a user name input field 210 and a password input field 212 for the established bank. Access to the user's account at the established bank may be accomplished through a validation and authentication API that directly interfaces with the banking system of the established bank. Once the user inputs the correct user name and password combination, a connection is established between the bank transfer system and the established bank's banking system, allowing the bank transfer system to access the user's account data, including transaction data. In some implementations, the first user interface 202 may include a user name input field and a password input field for a destination bank or other credentials used by the bank for validation.

A second user interface 204 displays the user's accounts at the established bank and at the destination bank. As shown in FIG. 2, the second user interface 204 may display accounts and products that a user has at the established bank. For example, the second user interface 204 may display checking accounts, savings accounts, certificates of deposit, credit lines, and other loans. The displayed accounts and information may be varied as desired or based on differing access levels provided by the bank. After the user has opened accounts at the destination bank, the second user interface 204 displays the user's account(s) at the destination bank so that the user may select destination bank accounts to involve in the transfer. For example, in the second user interface 204, the user has selected checking and savings accounts at bank A and a checking account at bank B. Accordingly, recurring transactions set up in the checking and savings accounts of bank A will be transferred to the checking account at bank B.

In some implementations, a user may begin using the bank transfer system without having enrolled or otherwise be able to access accounts at a destination bank. In these instances, the second user interface 204 may display options for accounts at the destination bank selected by the user. In another implementation, the second user interface 204 may present the user with several financial institutions that the user can select as the destination bank. In these implementations, the second user interface 204 may include links to additional information about account and financial institution options to assist the user in selecting a destination bank and destination accounts. In other words, the user may be able to utilize the system to select a new financial institution and act to open an account at a selected financial institution.

When the user selects accounts at the established bank the user wants to transfer to the destination bank, the bank transfer system sends a request to the established bank's banking system for transaction records associated with the selected accounts. For example, the user has selected bank A checking and bank A savings in the second user interface 204. In this example, the bank transfer system will request transaction records for the user's checking and savings accounts at bank A. Generally, the system will obtain up to two years of transaction records for the selected accounts at the established bank, but the time period requested may be varied based on transactions to be identified, user preferences, and the like. If there is not three months of transaction data available for the selected accounts, the bank transfer system may display an error or warning to the user indicating that the bank transfer system will be less likely to correctly identify recurring transactions with limited transaction data.

When the bank transfer system receives transaction data from the banking system of the established bank, the bank transfer system analyzes the transaction data to identify recurring transactions. An algorithm analyzes transactions in the transaction data to determine recurring transactions. For example, the algorithm looks for ACH transactions occurring around a similar date each month. Transactions with the same vendor in similar amounts may also be identified as recurring. The algorithm may identify both recurring payments (such as automatic and manual bill payments occurring around the same time each month) and recurring deposits (such as paychecks). The algorithm may look at all of the transaction history for an account as a whole to identify recurring transactions that occur, for example, quarterly, yearly, monthly, or biweekly.

A third user interface 206 displays recurring transactions identified by the bank transfer system. The user may select which of the recurring transactions to select for transfer to the destination bank. As shown in the third user interface 206, the bank transfer system may identify recurring transactions that occur on a variety of schedules. For example, the third user interface 206 shows payments occurring monthly, quarterly, and yearly. The bank transfer system may also identify recurring transactions occurring, for example, biweekly or biannually.

As shown in the third user interface 206, the bank transfer system may also identify recurring transactions having inconsistent or varying amounts per transfer. Further, the bank transfer system may be able to identify recurring deposits, such as automatic deposit of a paycheck. The user may select which of the identified recurring transactions to transfer to the destination bank.

In one implementation, the third user interface 206 includes an option for the user to identify additional recurring transactions that the bank transfer system did not identify or may have identified as possible recurring transactions. For example, the option may present a user interface or icon that displays an exemplary bank statement from the established bank and allows the user to select transactions directly from the bank statement, e.g., by selecting a transaction via an input mechanism. The area may also allow the user to manually enter amounts for other recurring transactions to transfer to the destination bank. The user interface 206 may also include an option to identify other possible service providers for the user using, for example, the method described with respect to FIG. 6.

In one implementation, the recurring transactions displayed on the third user interface 206 are formatted for identification and optionally readability. For example, the vendor name as listed on the bank statement may be converted to a commonly known name of the vendor so that the user may more easily identify the payment. This conversion may happen by comparing vendor names as listed on the received bank statements to a database including commonly known vendor names corresponding to vendor names as listed on statements. In some implementations, if a vendor name is not listed in the database, the user can manually enter the commonly known vendor name for a transaction to add the name to the database. A fourth user interface 208 displays the recurring transactions that have been transferred from the established bank to the destination bank.

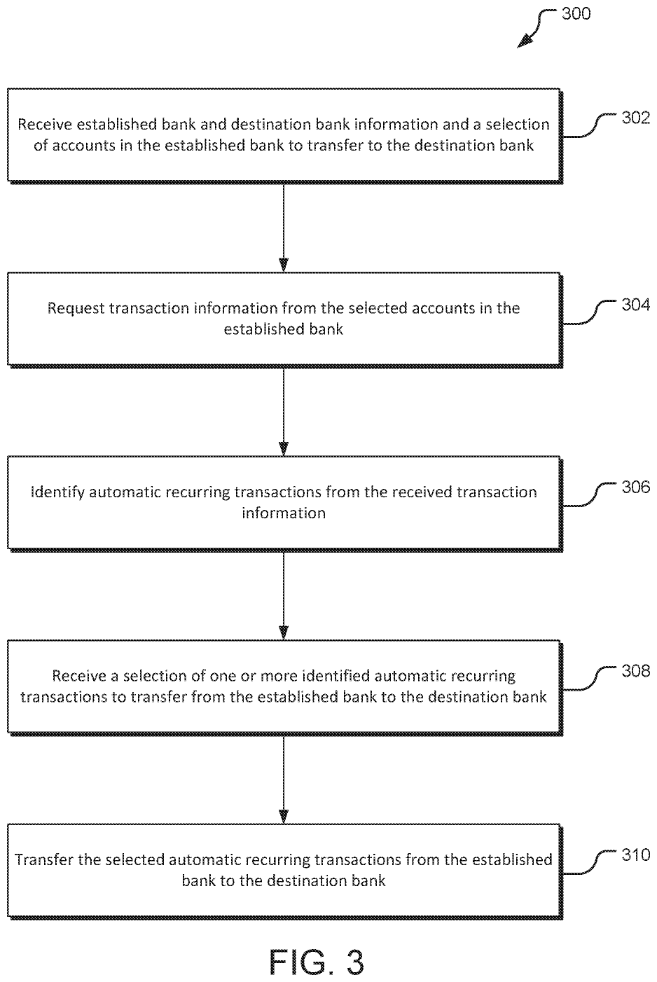

FIG. 3 is a flow diagram 300 of steps to transfer recurring transactions from an established bank to a destination bank using a bank transfer system. A first receiving operation 302 receives established bank and destination bank information. The first receiving operation 302 also receives a selection of accounts in the established bank to transfer to the destination bank.

The first receiving operation 302 receives established bank and destination bank information through a user interface. The user interface requests the user's user name and password (or other credentials, e.g., biometric information) for at least the established bank's banking system. In some implementations, the user interface may also request user name and password information for the destination bank. Along with the user's name and password for the established bank's banking system, the first receiving operation 302 may also receive a selection of accounts from the established bank and/or the destination bank that will be involved in the transfer. For example, in one implementation, after a connection is established between the bank transfer system the user interface displays a list of accounts at the established bank. The user may then select the accounts to include in the transfer. For example, a user may have a checking account, a savings account, and a certificate of deposit at the established bank. The user may choose to transfer only recurring transactions from the checking account at the established bank by selecting only the checking account for transfer.

A requesting operation 304 requests transaction information from the selected accounts in the established bank. The transaction information may include, for example, for each transaction involving the selected accounts in the established bank, transaction type (ACH transaction, debit card transaction, check deposit, etc.), transaction date, transaction amount, and vendor name. The requesting operation 304 may request transaction information for transactions falling within a specified date range at the established bank. For example, the requesting operation 304 may request transaction information for at least the previous three months, up to the previous two years.

An identifying operation 306 identifies recurring transactions from the received transaction information. When the bank transfer system receives transaction data from the banking system of the established bank, the bank transfer system analyzes the transaction data to identify recurring transactions. An algorithm analyzes each transaction in the transaction data to determine if it is a recurring transaction. For example, the algorithm looks for ACH transactions that occur around a similar date each month. Transactions with the same vendor in similar amounts may also be identified as recurring. The algorithm may identify both recurring payments (such as automatic and manual bill payments) and recurring deposits (such as paychecks). The algorithm may look at all of the transaction history for an account as a whole to identify recurring transactions that occur, for example, quarterly, yearly, monthly, or biweekly. In some implementations, the bank transfer system may utilize machine learning to increase its accuracy in identifying recurring transactions over time.

A second receiving operation 308 receives a selection of one or more identified recurring transactions to transfer from the established bank to the destination bank. The second receiving operation 308 receives the selection of one or more identified recurring transactions from the user. In one implementation, after the identifying operation 306 identifies recurring transactions from the received transaction information, the identified recurring transactions may be presented to the user. The user may then select which of the identified recurring transactions to transfer to the destination bank. For example, the identifying operation may automatically transfer recurring transactions for consistent amounts and present transactions to the same vendor with variable amounts to the user for verification. In other implementations, the user may enter information about recurring transactions not identified in the identifying operation 308.

A transferring operation 310 transfers the selected recurring transactions from the established bank to the destination bank. During the transferring operation 310 the bank transfer system communicates with a destination bank banking system to complete transfer of the transactions. For “push” transactions, where the bank pushes out payments to vendors on a specified schedule, the destination bank banking system updates the user's account to push out payments to the vendors on schedule. Further, the bank transfer system updates the established bank's account information to stop pushing out those payments from the user's account. For example, Visa® Account Updater (VAU) can be used to update the user's account.

For “pull” transactions, where the vendors pulls payment from the bank on a specified schedule, transfer of the transaction may be accomplished by updating account information in the vendor's system. Accordingly, where the user wishes to transfer pull transactions, the bank transfer system may use an API to allow the user to log into accounts on the vendor system so that the established bank banking system may communicate directly with the vendor system to update account information for recurring transactions.

In some implementations, recurring transactions and funds associated with the newly opened account may be transferred to a credit card or debit card associated with the destination bank accounts instead of being set up as transactions with the accounts. In some implementations, the bank transfer system may suggest an amount of money to transfer to the destination bank account. For example, the amount may be calculated based on the monetary amount of recurring transactions set up with the account.

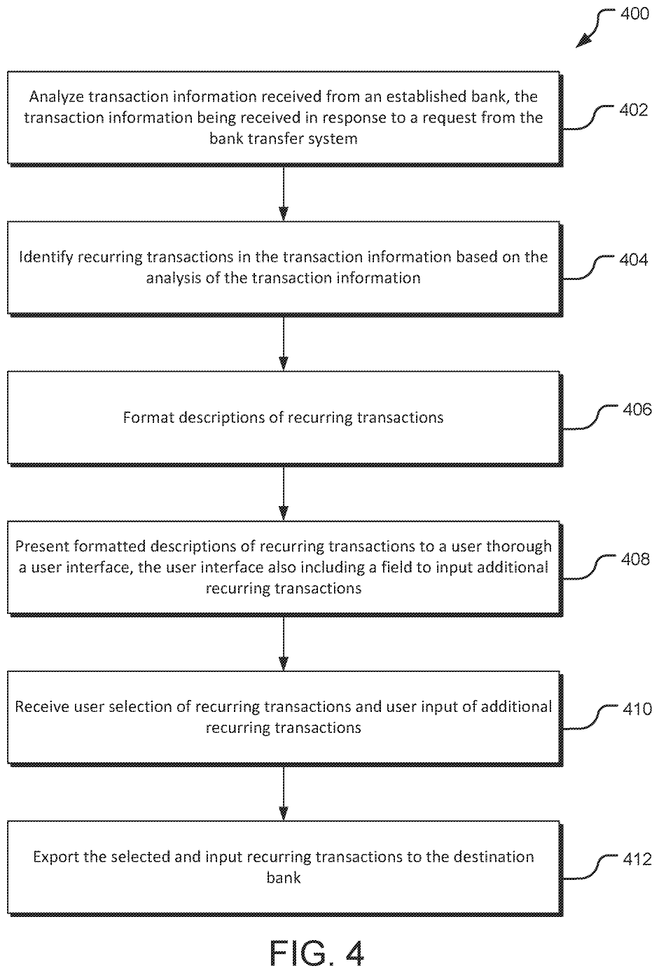

FIG. 4 is a flow diagram 400 of identifying and transferring recurring transactions using a bank transfer system. An analyzing operation 402 analyzes transaction information received from an established bank. The transaction information is received in response to a request from the bank transfer system to the established bank.

An identifying operation 404 identifies recurring transactions in the transaction information based on the analysis of the transaction information. When the bank transfer system receives transaction data from the banking system of the established bank, the bank transfer system analyzes the transaction data to identify recurring transactions. An algorithm analyzes each transaction in the transaction data to determine if it is a recurring transaction. For example, the algorithm looks for ACH transactions that occur around a similar date each month. Transactions with the same vendor in similar amounts may also be identified as recurring. The algorithm may identify both recurring payments (such as automatic bill payments) and recurring deposits (such as paychecks). The algorithm may look at all of the transaction history for an account as a whole to identify recurring transactions that occur, for example, quarterly, yearly, monthly, or biweekly.

A formatting operation 406 formats descriptions of the identified recurring transactions. For example, the formatting operation 406 may convert the vendor name as presented in the statement to a more common name more likely to be recognized by the user. The conversion of the vendor name may be based on a list of common vendor names corresponding to vendor names as presented on statements. Further, the formatting operation 406 may present the user with information on the frequency of the transaction, the average date of the transaction, and the normal amount (or range of amounts) of the transaction. A presenting operation 408 presents formatted descriptions of recurring transactions to the user through a user interface. The user interface also includes a field to input additional recurring transactions, including vendor names, transaction frequency, and transaction amounts.

A receiving operation 410 receives a user selection of the presented recurring transactions and user input of additional recurring transactions. An exporting operation 412 exports the identified recurring transactions to the destination bank. During the exporting operation 412, the bank transfer system communicates with a destination bank banking system to complete transfer of the transactions. For “push” transactions, where the bank “pushes” out payments to vendors on a specified schedule, the destination bank banking system updates the user's account to push out payments to the vendors on schedule. Further, the bank transfer system updates the established bank's account information to stop pushing out those payments from the user's account.

For “pull” transactions, where the vendors “pulls” payment from the bank on a specified schedule, transfer of the transaction may be accomplished by updating account information in the vendor's system. Accordingly, where the user wishes to transfer pull transactions, the bank transfer system may use a third party API to allow the user to log into accounts on the vendor system so that the established bank banking system may communicate directly with the vendor system to update account information for recurring transactions.

FIG. 5 is an example progression of a user interface 500 of a bank transfer system. In some implementations, the progression of the user interface 500 may occur when the user has not given the bank transfer system access to the user's accounts at an established bank. In other implementations, the progression of the user interface 500 may occur after the bank transfer system has identified recurring transactions from the user's accounts at the established bank. The user may then transfer recurring payments that were paid from other accounts (such as payments that were previously on a credit card) or payments that the user previously made manually each time the payment was due. In short, the method of FIG. 5 may be used based on client preference and/or to supplement the identification and transfer of recurring transactions.

A first user interface 502 provides fields for the entry of user information. For example, the user may enter a cell phone number and social security number (SSN) directly into the fields provided in the first user interface 502.

The first user interface 502 may also provide a launching point (e.g., a button or link) for identification verification. For example, the first user interface 502 includes a button for verification of the user's driver's license. When the user selects the button for verification of the user's driver's license, a user interface for verification may be presented within the bank transfer system. In other implementations, the user is routed to a third-party system for identification verification upon selecting the button for driver's license verification. The user may then be returned to the bank transfer system after the verification is complete. In some implementations, other official identification, such as state issued identification cards or passports may be used for verification in place of a driver's license.

Driver's license verification may include the upload of an image of the user's driver's license. In some implementations, driver's license verification also uses an image of the user taken using a camera on the user device. A verification system may then compare the image on the driver's license to the image of the user to ensure that the user is the person in the driver's license image.

In some implementations, the first user interface 502 may collect additional information not shown in FIG. 5. For example, the first user interface 502 may provide input fields for the user's address, full name, and other identifying information. Further, in some implementations, the first user interface 502 may include fields for login information for established bank accounts or for destination bank accounts. In these implementations, the recurring transaction transfer discussed above (e.g., the identification and transfer of recurring transactions disclosed in FIG. 4) may occur after the first user interface 502 is presented but before a second user interface 504 is presented.

The second user interface 504 provides a list of likely providers. The user may select from the list of likely providers in order to transfer or establish recurring transactions with selected providers. The list of likely providers may be obtained from third-party sources. For example, the bank transfer system may connect to a real estate API using the user information provided in the first user interface 502. The real estate API may locate properties owned by the user, along with providers (e.g., electric, water, gas, sewer, internet) that service the properties owned by the user. In other implementations, the bank transfer system may store providers on a database accessible by the bank transfer system. For example, a database may include lists of providers by ZIP code. The bank transfer system may obtain an address of the user from a driver's license during the driver's license verification in the first user interface 502. The bank transfer system may also include a field for ZIP code on the first user interface 502. The bank transfer system then obtains likely providers from the database using the user's ZIP code. In some implementations, public records for the user's address may be used to add to the list of likely providers. For example, when real estate records show a mortgage company as a lien holder, the mortgage company is added to the list of likely providers.

Using the second user interface 504, the user may select providers from the list of likely providers for recurring payment transfer. Is some implementations, when the second user interface 504 is presented after an initial identification of recurring payments from an established bank account, the second user interface 504 may include an indication that payments from a provider on the list of likely providers have already been identified and have either been transferred or are ready for transfer to the destination bank account.

After providers are selected using the second user interface 504, a third user interface 506 prompts the user to enter additional information to connect with accounts for the selected providers. The information used to connect accounts may vary by provider but may include, for example and without limitation, e-mail address, account number, user name, and password. Once account information is entered, the bank transfer system may access the user's statements to identify the amount and frequency of payments to a particular provider. In some implementations, the bank transfer system may use an API to connect to provider systems to gain access to statements. In some implementations, the third user interface 506 may allow the user to upload digital statements for providers or to manually enter payment data.

A fourth user interface 508 allows the user to select which recurring transactions to transfer to the established banking account. The fourth user interface 508 also allows the user to select an account at the established bank for transfer of the recurring transactions. In some implementations, the fourth user interface 508 may present the user with an opportunity to open an account at the established bank, if the account is not already opened. For push transactions, the recurring transactions are transferred by providing vendor and transaction information to the established bank. For pull transactions, recurring transactions are transferred by providing the user's established bank account information to the provider's system.

FIG. 6 is a flow diagram of transferring recurring transactions using a bank transfer system. A first receiving operation 602 receives user identification information through user identification verification. Identification verification may occur through a third party interface. For example, the user may be directed to a secure third party site where the user submits a picture of the user's government issued identification (e.g., a driver's license or passport) along with a picture of the user taken using the user's device camera. The third party verification software then verifies that the government issued identification is valid and that the submitted picture of the user matches the photograph on the government issued identification. In some implementations, the identification verification may happen within the bank transfer system, without directing the user to a third party site. Other information may be collected prior to or concurrent with the identification verification, such as the user's SSN, phone number, date of birth, address, ZIP code, or other relevant user information.

In some implementations, after providing identification information, the user may view and sign consents to allow the bank transfer system to, for example, access financial records, complete applications for new financial products, or perform credit checks. After receiving signed consents, the bank transfer system may pull credit information, background checks, or perform other verifications of the user's identity.

A connecting operation 604 connects to an API providing real estate data or other third party and public databases using the received user identification information. The API may be a real estate API that locates properties owned by the user, along with providers (e.g., electric, water, gas, sewer, internet) that service the properties owned by the user. Information received from the real estate API may be used in conjunction with public records to identify service providers utilized by the user. The API may also be used to access other financial information, such as loans that the user may have outstanding at other financial institutions.

An identifying operation 606 identifies likely service providers based on information retrieved through the application programming interface. The real estate API may locate properties owned by the user, along with providers (e.g., electric, water, gas, sewer, internet) that service the properties owned by the user. In other implementations, the bank transfer system may store providers on a database accessible by the bank transfer system. For example, a database may include lists of providers by ZIP code. The bank transfer system may obtain an address of the user from a driver's license during the driver's license verification. The bank transfer system may also include collect the user's ZIP code in the first receiving operation 602. The bank transfer system then obtains likely providers from the database using the user's ZIP code. In some implementations, public records for the user's address may be used to add to the list of likely providers. For example, when real estate records show a mortgage company as a lien holder, the mortgage company is added to the list of likely providers. In some implementations, the API may then access the mortgage company's databases to obtain additional information about the mortgage such as purchase price, loan amount, origination date, loan balance, and payment history.

A second receiving operation 608 receives a selection of service providers from a presented list of likely service providers. After likely service providers are identified, the bank transfer system presents the user with the list of likely service providers. The user then selects service providers from the list of likely service providers. In some implementations, where the bank transfer system has already identified recurring transactions through the user's established bank account, some service providers on the list of likely service providers may be displayed with an indication that recurring transactions relating to that service provider have already been identified.

A third receiving operation 610 receives access credentials for the selected service providers. The access credentials may vary by service provider but may include, for example and without limitation, e-mail address, account number, user name, and password. An accessing operation 612 accesses service provider systems for selected service providers to effect transfer of recurring transactions with the selected service providers. In some implementations, the bank transfer system may use an API to connect to provider systems to gain access to statements. For push transactions, the recurring transactions are transferred by providing vendor and transaction information to the established bank. For pull transactions, recurring transactions are transferred by providing the user's established bank account information to the provider's system.

In some implementations, additional operations may provide recommendations to the user based on information gathered by the bank transfer system. For example, the system may suggest alternate financial products (e.g., refinancing a mortgage) based on information gathered by the system during the transfer of recurring transactions. Additional operations may also allow the user to quickly apply for additional financial products.

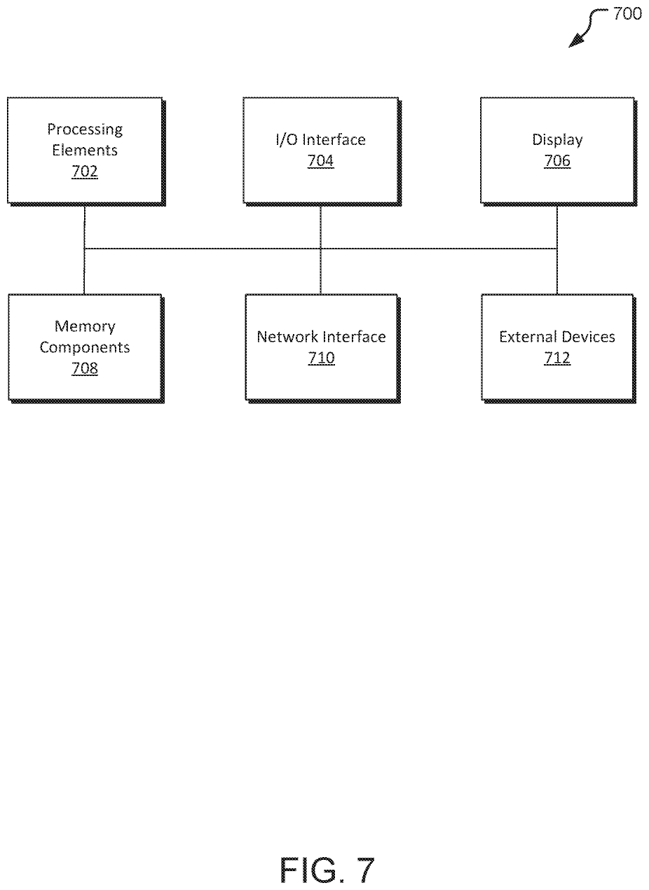

FIG. 7 is a schematic diagram of an example computer system for implementing various embodiments in the examples described herein. A computer system 700 may be used to implement the consumer device 104 (in FIG. 1) or integrated into one or more components of the bank transfer system 100. For example, the established bank requestor 112, the recurring transaction identifier 114, and/or the destination bank communicator 118 may include one or more of the components of the computer system 700 shown in FIG. 7. The computer system 700 is used to implement or execute one or more of the components or operations disclosed in FIGS. 1-6. In FIG. 7, the computer system 700 may include one or more processing elements 702, an input/output interface 704, a display 706, one or more memory components 708, a network interface 710, and one or more external devices 712. Each of the various components may be in communication with one another through one or more buses, communication networks, such as wired or wireless networks.

The processing element 702 may be any type of electronic device capable of processing, receiving, and/or transmitting instructions. For example, the processing element 702 may be a central processing unit, microprocessor, processor, or microcontroller. Additionally, it should be noted that some components of the computer 700 may be controlled by a first processor and other components may be controlled by a second processor, where the first and second processors may or may not be in communication with each other.

The memory components 708 are used by the computer 700 to store instructions for the processing element 702, as well as store data, such as the vendor data (e.g., 116 in FIG. 1), and the like. The memory components 708 may be, for example, magneto-optical storage, read-only memory, random access memory, erasable programmable memory, flash memory, or a combination of one or more types of memory components.

The display 706 provides visual feedback to a user, such as a display of the consumer device 104 (FIG. 1). Optionally, the display 706 may act as an input element to enable a user to control, manipulate, and calibrate various components of the bank transfer system 100 (FIG. 1) as described in the present disclosure. The display 706 may be a liquid crystal display, plasma display, organic light-emitting diode display, and/or other suitable display. In embodiments where the display 706 is used as an input, the display may include one or more touch or input sensors, such as capacitive touch sensors, a resistive grid, or the like.

The I/O interface 704 allows a user to enter data into the computer 700, as well as provides an input/output for the computer 700 to communicate with other devices or services (e.g., consumer device 104, established bank banking system 106, destination bank banking system 108 and/or other components in FIG. 1). The I/O interface 704 can include one or more input buttons, touch pads, and so on.

The network interface 710 provides communication to and from the computer 700 to other devices. For example, the network interface 710 allows the bank transfer system 100 (FIG. 1) to communicate with the consumer device 104 (FIG. 1) through a communication network. The network interface 710 includes one or more communication protocols, such as, but not limited to WiFi, Ethernet, Bluetooth, and so on. The network interface 710 may also include one or more hardwired components, such as a Universal Serial Bus (USB) cable, or the like. The configuration of the network interface 710 depends on the types of communication desired and may be modified to communicate via WiFi, Bluetooth, and so on.

The external devices 712 are one or more devices that can be used to provide various inputs to the computing device 700, e.g., mouse, microphone, keyboard, trackpad, or the like. The external devices 712 may be local or remote and may vary as desired. In some examples, the external devices 712 may also include one or more additional sensors.

The foregoing description has a broad application. For example, while examples disclosed herein may focus on central communication system, it should be appreciated that the concepts disclosed herein may equally apply to other systems, such as a distributed, central or decentralized system, or a cloud system. For example, the established bank requestor 112, the recurring transaction identifier 114, and/or other components in the bank transfer system 100 (FIG. 1) may reside on a server in a client/server system, on a user mobile device, or on any device on the network and operate in a decentralized manner. One or more components of the bank transfer system 100 (FIG. 1) may also reside in a controller virtual machine (VM) or a hypervisor in a VM computing environment. Accordingly, the disclosure is meant only to provide examples of various systems and methods and is not intended to suggest that the scope of the disclosure, including the claims, is limited to these examples.

The technology described herein may be implemented as logical operations and/or modules in one or more systems. The logical operations may be implemented as a sequence of processor-implemented steps directed by software programs executing in one or more computer systems and as interconnected machine or circuit modules within one or more computer systems, or as a combination of both. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products that cause the instantiation of operations on a computer system to implement the procedural operations. One implementation of a computer program product provides a non-transitory computer program storage medium readable by a computer system and encoding a computer program. It should further be understood that the described technology may be employed in special purpose devices independent of a personal computer.

The above specification, examples and data provide a complete description of the structure and use of exemplary embodiments of the invention as defined in the claims. Although various embodiments of the claimed invention have been described above with a certain degree of particularity, or with reference to one or more individual embodiments, it is appreciated that numerous alterations to the disclosed embodiments without departing from the spirit or scope of the claimed invention may be possible. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A method of identifying recurring transactions to transfer to a financial institution comprising:
receiving user information including at least an image of a government issued identification and a verifiable user identification;
verifying an identity of the user based on the received user information;
identifying, based on received user information, potential service providers that may provide services to a user;
receiving a selection of service providers from a list of the identified potential service providers presented to the user;
identifying recurring transactions between the user and the selected service providers; and
exporting the identified recurring transactions to the financial institution.

2. The method of claim 1 wherein the potential service providers are identified using real estate information.

3. The method of claim 1, wherein the verifiable user identification comprises at least one of the user's social security number, phone number, date of birth, address, or ZIP code.

4. A method of using a bank transfer system to identify recurring transactions in an account of a user at a first financial institution to transfer the recurring transactions from the first financial institution to a second financial institution, the method comprising:
analyzing transaction information received from the first financial institution, the transaction information being received in response to a request from the bank transfer system, the transaction information including records of transactions in the account of the user at the first financial institution over a transaction period;
identifying recurring transactions in the transaction information based on the analysis of the transaction information; and
exporting the identified recurring transactions to the second financial institution.

5. The method of claim 4 wherein the records of transactions comprising a plurality of transactions;
wherein identifying recurring transactions comprising assigning a certainty score to each of the plurality of transactions and identifying one of the plurality of transactions as a recurring transaction if the certainty score for the one of the plurality of transactions exceeds a threshold certainty score.

6. The method of claim 4, further comprising:
formatting descriptions of the identified recurring transactions by comparing the vendor names appearing in the transaction information to a list of corresponding commonly known vendor names.

7. The method of claim 6, wherein formatting the identified recurring transactions also includes identifying a transaction frequency and a transaction amount.

8. The method of claim 6, further comprising:
presenting formatted descriptions of the identified recurring transactions to a user through a user interface.

9. The method of claim 8, further comprising:
receiving a selection of recurring transactions from the user, the selection of recurring transactions being a subset of the presented identified recurring transactions.

10. The method of claim 4, further comprising:
receiving additional transaction information from a user interface, the additional transaction information relating to additional recurring transactions.

11. The method of claim 4, further comprising:
presenting the user with destination bank information, the destination bank information including account features at one or more destination banks.

12. The method of claim 11, further comprising:
receiving a selection of the second financial institution from the one or more destination banks presented to the user.

13. The method of claim 4, wherein the transaction information received from the first financial institution is transaction information for a selected subset of the accounts of the user at the first financial institution.

14. The method of claim 13, wherein the selected subset of the accounts of the user at the established bank is selected by the user.

15. A bank transfer system for identifying recurring transactions in an account of a user at a first financial institution to transfer the recurring transactions from the first financial institution to a second financial institution, the bank transfer system comprising:
a network interface configured to communicate with a first banking system of the first financial institution and a second banking system of the second financial institution; and
one or more processing elements configured to:
analyze transaction information received from the first banking system of the first financial institution, the transaction information being received in response to a request from the bank transfer system, the transaction information including records of transactions in the account of the user at the first financial institution over a transaction period,
identify recurring transactions in the transaction information based on the analysis of the transaction information, and
export the identified recurring transactions to the second financial institution.

16. The bank transfer system of claim 15, wherein the network interface is further configured to communicate with a third party database to obtain additional data about the user.

17. The bank transfer system of claim 15, wherein the potential service providers include utility providers identified using real estate data.

18. The bank transfer system of claim 15, wherein the potential service providers include financial service providers providing debt products to the user.

19. The bank transfer system of claim 15, wherein the one or more processing elements are further configured to facilitate transfer of money from the account at the first financial institution to a card associated with an account of the user at the second financial institution.

20. The bank transfer system of claim 15, wherein the one or more processing elements are further configured to obtain user information from an image of a government issued identification for the user.
